(19) United States
(12) Patent Application Publication
(10) Pub. No.: US 2026/0349747 A1
(43) Pub. Date: Nov. 5, 2026

(54) METHOD AND SYSTEM FOR AUTOMATICALLY CONVERTING VOICE DATA INTO EXECUTABLE WORKFLOW

(71) Applicant: TWAI Inc., Grand Cayman (KY)

(72) Inventor: CHE-MIN CHUNG, Kaohsiung City (TW)

(21) Appl. No.: 19/651,821

(22) Filed: Apr. 20, 2026

Related U.S. Application Data
(60) Provisional application No. 63/790,722, filed on Apr. 18, 2025.

(51) Int. Cl. G06F 9/445; G06F 40/30; G06V 30/19; G10L 15/26

(52) U.S. Cl. CPC G06F 9/445; G06F 40/30; G06V 30/19173; G10L 15/26

(57) ABSTRACT

A method for automatically converting voice data into an executable workflow comprises: receiving a voice signal and converting the voice signal into electronic text content; performing, using a large language model, a semantic analysis on the electronic text content to identify a relationship among verbs, time points, and a subject, and generating to-do tasks accordingly each including a task executor and/or a task completion deadline; classifying the to-do tasks according to the verbs and the time points to generate task types; determining a logical dependency relationship among the to-do tasks according to a result of the semantic analysis; generating an automated workflow including a process node and a logic construct according to the task types and the logical dependency relationship; and generating a programmatic instruction according to the automated workflow to call an application corresponding to each to-do task. A system using the above method is also provided.

### CROSS-REFERENCE TO RELATED APPLICATIONS

This application claims priority to and the benefit of U.S. Provisional Patent Application Ser. No. 63/790,722, filed on Apr. 18, 2025, the entire contents of which are incorporated herein by reference.

### FIELD

The present invention relates to workflow automation technology, and more particularly, to a method and system for automatically converting voice data into an executable workflow.

### BACKGROUND

In modern enterprise operations, a meeting is an important occasion for making decisions, assigning tasks, and coordinating work. After a meeting ends, participants typically need to spend a large amount of time manually organizing the content of the meeting, recording the to-do tasks, responsible persons, and completion deadlines mentioned during the discussion one by one, and manually creating task lists, sending notification emails, or scheduling calendar events. This process is not only time-consuming but is also prone to omission of important matters due to human oversight, resulting in delays in subsequent execution.

Although some tools currently exist that can automatically convert meeting recordings into transcripts or generate meeting summaries, such tools are limited to converting voice into text or generating a static to-do list, and a user still needs to interpret the content and manually assign the tasks to a corresponding application or enterprise system for execution. Therefore, how to further improve the degree of automation in processing meeting content is a problem to be solved in this field.

### SUMMARY

In view of the above, the present invention provides a method and system for automatically converting voice data into an executable workflow, which performs semantic analysis, through a large language model, on electronic text content converted from voice, automatically extracts to-do tasks and determines logical dependency relationships between the to-do tasks, and thereby constructs an automated workflow that can be directly executed, so as to solve the above problem.

A first aspect of the present invention provides a method for automatically converting voice data into an executable workflow, and the method comprises: receiving a voice signal and converting the voice signal into electronic text content; performing, using a large language model, a semantic analysis on the electronic text content to identify a relationship among a plurality of verbs, a plurality of time points and at least one subject in the electronic text content and generating a plurality of to-do tasks accordingly, wherein each of the plurality of to-do tasks includes at least one of a task executor and a task completion deadline; classifying the plurality of to-do tasks according to the plurality of verbs and the plurality of time points to generate a plurality of task types; determining a logical dependency relationship among the plurality of to-do tasks according to a result of the semantic analysis; generating an automated workflow including at least one process node and at least one logic construct according to the plurality of task types and the logical dependency relationship; and generating at least one programmatic instruction according to the automated workflow to call an application corresponding to each of the plurality of to-do tasks.

In some embodiments of the first aspect, the method further comprises: extracting a data query requirement from the electronic text content; constructing a contextual prompt instruction according to the data query requirement; translating the contextual prompt instruction into a structured query language, so as to obtain target data from at least one data source; and generating a corresponding visualized output according to the target data.

In some embodiments of the first aspect, the at least one logic construct includes at least one of the following: a conditional execution branch configured to determine a subsequent process node according to an execution result of the to-do task; a parallel execution branch configured to simultaneously call the application corresponding to each of the to-do tasks; and a waiting condition configured to suspend execution of the automated workflow until the waiting condition is satisfied.

In some embodiments of the first aspect, generating the at least one programmatic instruction to call the application corresponding to each of the to-do tasks further comprises: determining a target enterprise system according to the task executor in each of the to-do tasks; generating an application programming interface (API) call instruction of the target enterprise system according to each of the to-do tasks; and sending the application programming interface call instruction to the target enterprise system, so as to execute the programmatic instruction corresponding to each of the to-do tasks.

In some embodiments of the first aspect, the method further comprises: identifying at least one item to be verified from the electronic text content according to a result of the semantic analysis; generating and executing a corresponding test procedure according to the item to be verified; and generating a test report according to an execution result of the corresponding test procedure.

In some embodiments of the first aspect, constructing the contextual prompt instruction further comprises: identifying a speaker feature of a speaker who raised the data query requirement, wherein the speaker feature includes a department attribute or a permission level; and encapsulating the speaker feature into the contextual prompt instruction, such that the structured query language is limited to a data access scope corresponding to the speaker feature, so as to perform permission filtering on the data source.

A second aspect of the present invention provides a system for automatically converting voice data into an executable workflow, and the system comprises a memory and a processor. The memory is configured to store at least one instruction, and the processor is coupled to the memory and configured to execute the at least one instruction to: receive a voice signal and convert the voice signal into electronic text content; perform, using a large language model, a semantic analysis on the electronic text content to identify a relationship among a plurality of verbs, a plurality of time points, and at least one subject in the electronic text content and generate a plurality of to-do tasks accordingly, wherein each of the plurality of to-do tasks includes at least one of a task executor and a task completion deadline; classify the plurality of to-do tasks according to the plurality of verbs and the plurality of time points to generate a plurality of task types; determine a logical dependency relationship among the plurality of to-do tasks according to a result of the semantic analysis; generate an automated workflow including at least one process node and at least one logic construct according to the plurality of task types and the logical dependency relationship; and generate at least one programmatic instruction according to the automated workflow to call an application corresponding to each of the plurality of to-do tasks.

In some embodiments of the second aspect, the processor is further configured to execute the at least one instruction to: extract a data query requirement from the electronic text content; construct a contextual prompt instruction according to the data query requirement; translate the contextual prompt instruction into a structured query language, so as to obtain target data from at least one data source; and generate a corresponding visualized output according to the target data.

In some embodiments of the second aspect, the at least one logic construct includes at least one of the following: a conditional execution branch configured to determine a subsequent process node according to an execution result of the to-do task; a parallel execution branch configured to simultaneously call the application corresponding to each of the to-do tasks; and a waiting condition configured to suspend execution of the automated workflow until the waiting condition is satisfied.

In some embodiments of the second aspect, generating the at least one programmatic instruction to call the application corresponding to each of the to-do tasks further comprises: determining a target enterprise system according to the task executor in each of the to-do tasks; generating an application programming interface (API) call instruction of the target enterprise system according to each of the to-do tasks; and sending the application programming interface call instruction to the target enterprise system, so as to execute the programmatic instruction corresponding to each of the to-do tasks.

In some embodiments of the second aspect, the processor is further configured to execute the at least one instruction to: identify at least one item to be verified from the electronic text content according to a result of the semantic analysis; generate and execute a corresponding test procedure according to the item to be verified; and generate a test report according to an execution result of the corresponding test procedure.

In some embodiments of the second aspect, when constructing the contextual prompt instruction, the processor is further configured to execute the at least one instruction to: identify a speaker feature of a speaker who raised the data query requirement, wherein the speaker feature includes a department attribute or a permission level; and encapsulate the speaker feature into the contextual prompt instruction, such that the structured query language is limited to a data access scope corresponding to the speaker feature, so as to perform permission filtering on the data source.

### BRIEF DESCRIPTION OF THE DRAWINGS

FIG. 1 is a flowchart of a method for automatically converting voice data into an executable workflow according to an embodiment of the present invention;

FIG. 2 is a schematic diagram of an automated workflow according to an embodiment of the present invention;

FIG. 3 is a schematic block diagram of a computing system according to an embodiment of the present invention.

### DETAILED DESCRIPTION OF PREFERRED EMBODIMENTS

Reference will now be made in detail to embodiments of the present invention, illustrating a method and system for automatically converting voice data into an executable workflow, in which identical components are denoted by identical reference numerals.

The following description contains specific information related to exemplary embodiments of the present invention. The drawings in the present invention and the accompanying detailed description are merely exemplary embodiments. However, the present invention is not limited to these exemplary embodiments. Other variations and embodiments of the present invention will occur to those skilled in the art. Unless otherwise specified, identical or corresponding elements in the drawings may be indicated by identical or corresponding reference numerals. In addition, the drawings and illustrations in the present invention are generally not drawn to scale and are not intended to correspond to actual relative dimensions.

For purposes of consistency and ease of understanding, identical features are indicated by reference numerals in the exemplary drawings (although this may not be the case in some examples). However, features in different embodiments may differ in other respects, and therefore should not be narrowly limited to the features shown in the drawings.

Terms such as “at least one embodiment,” “an embodiment,” “various embodiments,” “different embodiments,” “some embodiments,” “the present embodiment,” and the like may indicate that the embodiment(s) of the present invention so described may include a particular feature, structure, or characteristic, but not every possible embodiment of the present invention necessarily includes the particular feature, structure, or characteristic. In addition, repeated use of the phrases “in an embodiment” and “in the present embodiment” does not necessarily refer to the same embodiment, although they may. Furthermore, phrases such as “embodiment” used in connection with “the present invention” do not imply that all embodiments of the present invention must include the particular feature, structure, or characteristic, and should be understood as “at least some embodiments of the present invention” including the particular feature, structure, or characteristic described. The term “coupled” is defined as connected, whether directly or indirectly through intervening elements, and is not necessarily limited to a physical connection. When the term “comprising” is used, it means “including but not limited to,” which expressly indicates an open-ended inclusion or relationship of the stated combination, group, series, and equivalents.

In addition, for purposes of explanation and not limitation, specific details such as functional entities, techniques, protocols, standards, and the like are set forth to provide an understanding of the described technology. In other instances, detailed descriptions of well-known methods, techniques, systems, architectures, and the like are omitted to avoid unnecessarily obscuring the description.

The terms “first,” “second,” and “third” used in the specification of the present invention and the above drawings are used to distinguish different objects and are not used to describe a particular order. In addition, the term “comprising” and its variants are intended to cover a non-exclusive inclusion. For example, a process, method, system, product, or device that includes a series of steps or modules is not limited to the listed steps or modules but may optionally further include steps or modules not listed or may optionally further include other steps or modules inherent to such process, method, product, or device.

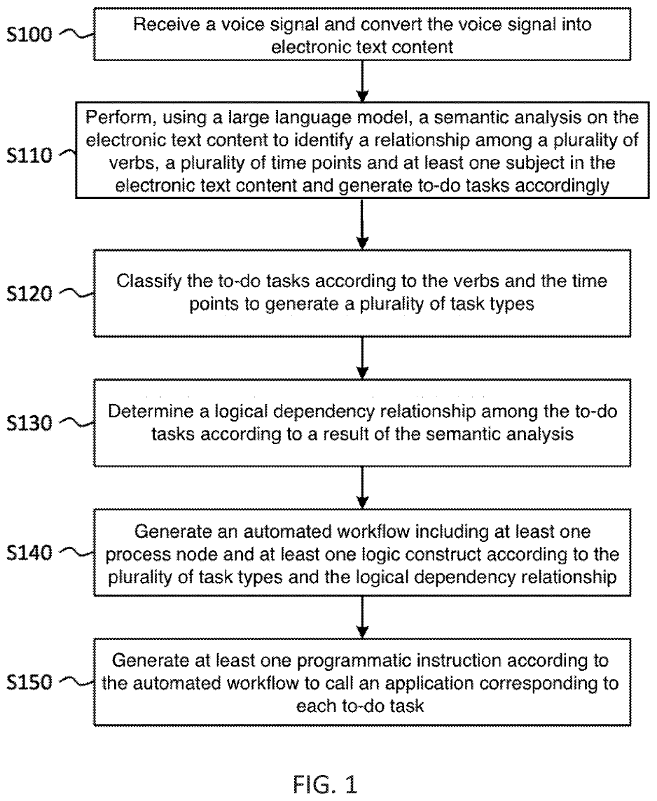

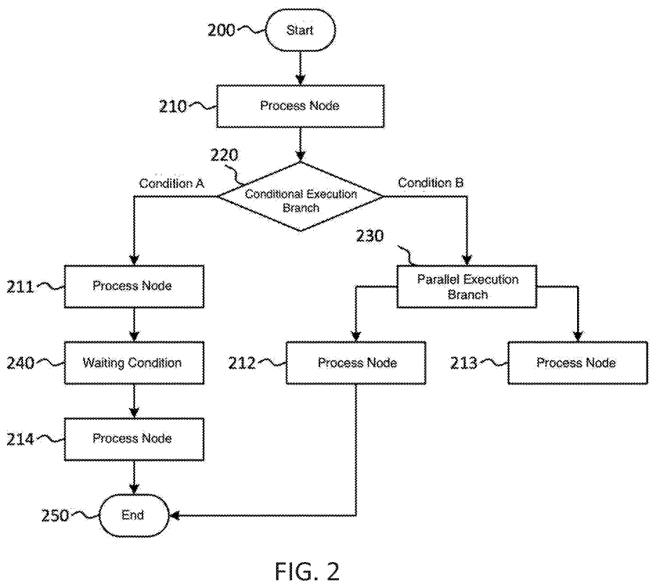

FIG. 1 is a flowchart of a method for automatically converting voice data into an executable workflow according to an embodiment of the present invention. FIG. 2 is a schematic diagram of an automated workflow according to an embodiment of the present invention.

Referring to FIG. 1 and FIG. 2, the method of the present embodiment may be executed by a computing device, and the computing device includes a memory and a processor (described in subsequent drawings). The method performs semantic analysis on voice data through a large language model, automatically extracts to-do tasks, and determines logical dependency relationships among the to-do tasks, thereby constructing an automated workflow, for example as shown in FIG. 2, which is sequentially executed from a start 200 to an end 250.

In step S100, the computing device receives a voice signal and converts the voice signal into electronic text content. Specifically, the computing device receives a voice signal of a user from an input terminal, and the voice signal may originate from a live-recorded meeting recording, a pre-stored voice file, an audio stream generated by a video conferencing system, or the like. In some embodiments, the computing device may convert the voice content in the voice signal into corresponding electronic text content through an automatic speech recognition engine. In some embodiments, the computing device may further perform post-processing operations such as sentence segmentation, noise filtering, or punctuation correction on the electronic text content, so as to improve the accuracy of subsequent semantic analysis.

In some embodiments, when receiving the voice signal, the computing device may further identify a plurality of speaker identities in the voice signal and map each speech segment in the electronic text content to the identified speaker. Specifically, the computing device may distinguish different speakers in the voice signal through a voiceprint analysis technique and identify the identity of each speaker according to a pre-established voiceprint database, a list of meeting participants, or participant metadata provided by a meeting platform.

In some embodiments, when extracting the to-do task using the large language model, the computing device may further map the identified speaker identity to the task executor of the to-do task, such that the task executor of the to-do task can be accurately mapped to a person mentioned in the electronic text content.

For example, when Alice says, in a meeting recording, “please have Bob complete the requirement assessment by Friday,” the computing device may identify, through voiceprint analysis, that the speaker of this sentence is Alice, and map “Bob” to the person identified as Bob among the meeting participants, such that the task executor field of the generated to-do task is explicitly assigned to Bob, rather than merely represented by the text “Bob.” Advantageously, through identification and binding of speaker identity, the present invention can avoid task assignment confusion caused by participants with the same name or by pronouns during a meeting, thereby improving the accuracy and executability of the to-do task.

In step S110, the computing device performs, using a large language model, a semantic analysis on the electronic text content to identify a relationship among a plurality of verbs, a plurality of time points, and at least one subject in the electronic text content and generates to-do tasks accordingly. The to-do tasks include at least one of a task executor and a task completion deadline. Specifically, the computing device inputs the electronic text content into a pre-trained large language model, and the large language model converts unstructured conversation content into a structured to-do task by identifying a semantic association among the verbs, the time points, and the subject in the electronic text content.

In detail, the large language model is a natural language processing model based on a deep learning architecture, which, through pre-training on a large-scale corpus, has the capability to understand the semantics, grammar, and contextual context of natural language. In some embodiments, the large language model may adopt a model based on a Transformer architecture, such as a model of the GPT series, the LLaMA series, the Gemini series, or the Claude series. Those of ordinary skill in the art should understand that the large language model used in the present invention is not limited to the specific models described above, and any model capable of performing semantic analysis on natural language and extracting structured information may be applied in the present invention. Advantageously, by adopting a large language model having semantic understanding capability, the present invention can accurately extract key information of the to-do task from various types of unstructured conversation content without requiring rule-based configuration for a specific field or a specific sentence pattern, thereby greatly improving the versatility and robustness of the present invention in different application scenarios.

For example, when the electronic text content includes the sentence “Alice will complete the requirement assessment by Friday,” the large language model may identify the relationship among the subject “Alice,” the verb “complete,” the time point “Friday,” and the action object “requirement assessment,” and generate a to-do task accordingly. The task content is “complete the requirement assessment,” the task executor is “Alice,” and the task completion deadline is “Friday.” In some embodiments, when the electronic text content includes a plurality of sentences, the large language model may simultaneously identify a plurality of sets of relationships among verbs, time points, and subjects and generate a plurality of to-do tasks accordingly.

In step S120, the computing device classifies the to-do tasks according to the verbs and the time points to generate a plurality of task types. Specifically, the computing device classifies the to-do tasks into different task types according to the semantics of the verb and the attribute of the time point corresponding to each to-do task. The semantics of the verb may reflect the nature of the action to be performed by the to-do task, and the time point may reflect the urgency or execution order of the to-do task.

For example, a to-do task having a verb such as “send,” “notify,” or “reply” that is communicative in nature may be classified as a “communication-type task”; a to-do task having a verb such as “convene,” “schedule,” or “book” that is scheduling in nature may be classified as a “meeting-type task”; a to-do task having a verb such as “purchase,” “place an order,” or “order” that is transactional in nature may be classified as a “procurement-type task”; and a to-do task having a verb such as “draft,” “prepare,” or “organize” that is document-producing in nature may be classified as a “document-type task.” In some embodiments, the computing device may further classify to-do tasks of the same type into “immediate tasks,” “short-term tasks,” or “long-term tasks” according to the time point, so as to facilitate subsequent arrangement of the workflow.

In step S130, the computing device determines a logical dependency relationship among the to-do tasks according to a result of the semantic analysis. Specifically, the computing device determines a sequential relationship or a conditional relationship in an execution order among the to-do tasks, according to the result of the semantic analysis performed on the electronic text content by the large language model in step S110. In detail, the large language model may identify a semantic cue expressing a temporal relationship in the electronic text content (such as “after,” “upon completion,” “then,” “simultaneously,” etc.), and a semantic cue expressing a conditional relationship (such as “if,” “provided that,” “when,” etc.), and determine the logical dependency relationship among the to-do tasks accordingly.

For example, when the electronic text content includes the sentence “after Bob compiles Document A on Monday, Amy will send it to the client on Tuesday,” the computing device may determine that execution of the to-do task “Amy sends the document” is conditioned on completion of the to-do task “Bob compiles Document A,” that is, a sequential-triggering logical dependency relationship exists between the two to-do tasks. As another example, when the electronic text content includes the sentence “if Supplier B's new quotation exceeds the budget by 15%, then request a quotation from Supplier C instead,” the computing device may determine that execution of the to-do task “request a quotation from Supplier C” is conditioned on satisfaction of the condition “Supplier B's quotation exceeds the budget by 15%,” that is, a condition-triggering logical dependency relationship exists between the two to-do tasks.

In step S140, the computing device generates an automated workflow including at least one process node and at least one logic construct according to the task types and the logical dependency relationship. Specifically, the computing device converts each to-do task into a process node in the automated workflow and establishes a corresponding logic construct between the process nodes according to the logical dependency relationship determined in step S130, so as to form an automated workflow that can be subsequently executed.

For example, the automated workflow generated by the computing device may be as shown in FIG. 2, entering a first process node 210 from a start 200. The first process node 210 corresponds to a to-do task (for example, “send the meeting minutes to the email inboxes of the project members”). After execution of the first process node 210 is completed, the automated workflow enters a conditional execution branch 220, and the conditional execution branch 220 determines a subsequent path according to an execution result of the first process node 210: when the execution result satisfies condition A (for example, all project members have successfully received the email), the automated workflow enters a second process node 211 (for example, “create a tracking item in the project management system”); when the execution result satisfies condition B (for example, email delivery has failed for some project members), the automated workflow enters a parallel execution branch 230. The parallel execution branch 230 may simultaneously trigger a third process node 212 and a fourth process node 213. For example, the to-do task corresponding to the third process node 212 is “resend the email to the members for whom delivery failed,” and the to-do task corresponding to the fourth process node 213 is “create a reminder event in the calendar.” The two to-do tasks may be executed simultaneously without waiting for each other. After the second process node 211 is completed, the automated workflow enters a waiting condition 240, and the waiting condition 240 is used to suspend execution of the automated workflow. For example, the waiting condition may be “wait for the project member to mark the tracking item as read,” and the automated workflow proceeds to a fifth process node 214 (for example, “update the task status to completed and notify the project leader”) only after the waiting condition is satisfied, ultimately reaching an end 250 to complete the entire automated workflow.

In some embodiments, the logic construct may include at least one of the conditional execution branch 220, the parallel execution branch 230 and the waiting condition 240. The conditional execution branch 220 is configured to determine a subsequent process node according to an execution result of the to-do task corresponding to a preceding process node. For example, when Supplier B's quotation result satisfies a predetermined condition, the automated workflow enters a process node for confirming the order, and otherwise enters a process node for requesting a quotation from Supplier C. The parallel execution branch 230 is configured to simultaneously call the application corresponding to each to-do task. For example, when it is mentioned in a meeting that “Linda places an order with Supplier A while Tom negotiates a price with Supplier B,” the computing device may simultaneously trigger execution of the two to-do tasks without waiting for either one to complete first. The waiting condition 240 is configured to suspend execution of the automated workflow until the waiting condition is satisfied, and the waiting condition may be completion of a preceding to-do task, arrival of a specific time, a return signal from an external system, or the like. Advantageously, by structuring the logical dependency relationships among the to-do tasks into an executable logic construct, the present invention can automatically convert unstructured conversation content into an automated workflow having complete flow control capability without requiring manual intervention, thereby greatly reducing the time cost for a user to manually create a task flow after a meeting.

In some embodiments, after generating the automated workflow, the computing device may further store the automated workflow as a workflow version available for review and execute the automated workflow only after the review is passed. Specifically, after generating the automated workflow, the computing device may present the automated workflow together with a corresponding visualized flowchart on a user interface for a person having review authority to confirm whether the content of the automated workflow conforms to the resolutions of the meeting; and after the automated workflow passes the review, the computing device triggers the action corresponding to each to-do task according to the automated workflow. Advantageously, through the introduction of a review mechanism, the present invention can avoid erroneous action execution caused by a misjudgment in the semantic analysis of the large language model, allowing the present invention to balance automation efficiency and decision accuracy in an actual enterprise application scenario.

In step S150, the computing device generates at least one programmatic instruction according to the automated workflow to call an application corresponding to each to-do task. Specifically, the computing device generates a corresponding programmatic instruction according to the to-do task content, the task executor, and the task type corresponding to each of the process nodes 210 to 214 in the automated workflow, and calls, through the programmatic instruction, the corresponding application to execute the action corresponding to the to-do task.

For example, when the to-do task corresponding to the second process node 211 is “send the meeting summary to the project members,” the computing device may launch an email system, and, through an application programming interface of the email system, automatically generate an email including the content of the meeting summary and send it to the corresponding task executor. As another example, when the to-do task corresponding to the fifth process node 214 is “add the requirement assessment task to Alice's calendar,” the computing device may launch a calendar system, and, through an application programming interface of the calendar system, automatically add the to-do task content and the task completion deadline to Alice's calendar. Advantageously, by automatically generating a programmatic instruction and calling the corresponding application, the present invention can achieve end-to-end automation from a meeting conversation to actual task execution, allowing a user to complete all subsequent execution actions without manually switching between different applications or repeatedly entering the task content.

In some embodiments, when triggering the action corresponding to each to-do task according to the automated workflow, the computing device may further monitor the execution status of each programmatic instruction. Specifically, the computing device may track a response result of a target application after sending a programmatic instruction, and, upon determining that execution of the programmatic instruction has failed, the computing device may execute a corresponding disposition according to a predetermined exception handling rule.

In some embodiments, the exception handling rule may include a retry mechanism, alternative path switching, or a manual intervention notification. When a programmatic instruction fails due to a temporary cause (such as a network anomaly or a brief unresponsiveness of the target application), the computing device may retry sending the programmatic instruction after a predetermined interval; when a programmatic instruction fails because the target application is unavailable, the computing device may switch to a backup target application according to an alternative path in the automated workflow; and when a programmatic instruction fails because the content of the to-do task exceeds a range that can be automatically processed by the system, the computing device may send a notification to a predetermined person, requesting manual intervention.

For example, when a programmatic instruction for the to-do task “create a meeting event in the calendar system” fails to execute because the calendar system is temporarily unresponsive, the computing device may retry sending the programmatic instruction after thirty seconds; and when the retry still fails after three attempts, the computing device may send a notification to the task executor and temporarily mark the status of the to-do task as “pending manual confirmation,” so that execution of the subsequent workflow can continue without being interrupted due to the failure of a single to-do task. Advantageously, through the monitoring and exception handling mechanism, the present invention can stably execute the automated workflow in an actual enterprise application environment, thereby improving the fault tolerance and availability of the system.

In some embodiments, the computing device may further extract a data query requirement from the electronic text content and generate a visualized output. Specifically, the computing device may extract a data query requirement from the electronic text content, construct a contextual prompt instruction according to the data query requirement, translate the contextual prompt instruction into a structured query language so as to obtain target data from at least one data source, and generate a corresponding visualized output according to the target data.

In detail, when the electronic text content includes a sentence related to a data query, the computing device may identify the data query requirement corresponding to the sentence and dynamically construct a contextual prompt instruction according to the data query requirement, wherein the contextual prompt instruction includes parameters such as a query object, a query scope, and a query condition. The computing device further translates the contextual prompt instruction into a structured query language (such as SQL or GraphQL) and sends a query request to a data source (such as an internal enterprise database, a customer relationship management system, or an external application programming interface) to obtain the target data.

For example, when the electronic text content includes the sentence “how many customer complaints were there for Product B last week? give me a trend chart,” the computing device may identify the data query requirement as “the number of customer complaints for Product B,” the query scope as “last week,” and the visualization type as “trend chart,” and construct a contextual prompt instruction accordingly. The computing device further translates the contextual prompt instruction into a corresponding database query statement, obtains data on the number of customer complaints for Product B last week from a customer relationship management system, and renders the obtained target data into a line trend chart as the visualized output.

In some embodiments, when constructing the contextual prompt instruction, the computing device may further identify a speaker feature of a speaker who raised the data query requirement. The speaker feature may include a department attribute or a permission level. The computing device encapsulates the speaker feature into the contextual prompt instruction, such that the structured query language is limited to a data access scope corresponding to the speaker feature, so as to perform permission filtering on the data source.

For example, when the speaker who raised the data query requirement is a general employee of the sales department, the computing device may encapsulate the speaker's department attribute and permission level into the contextual prompt instruction, such that the generated structured query language can only access customer complaint data belonging to the sales department and cannot access data of other departments. Advantageously, by performing permission filtering at the prompt instruction level, the present invention can complete permission control at a stage prior to the data query, thereby avoiding the risk of sensitive data leakage and satisfying enterprise requirements for data security and compliance.

In some embodiments, the computing device may further perform the steps of identifying an item to be verified from the electronic text content and generating a test report. Specifically, the computing device may identify at least one item to be verified from the electronic text content according to a result of the semantic analysis, generate and execute a corresponding test procedure according to the item to be verified, and generate a test report according to an execution result of the corresponding test procedure.

For example, when the electronic text content includes the sentence “a customer reported that the app crashes when tapping the checkout button on iOS 16,” the computing device may identify that the content described in this sentence is not a task to be assigned, but rather a software defect item to be verified. The computing device further generates a corresponding test procedure according to this item to be verified (for example, launching the application in an iOS 16 environment and sequentially performing the operations of adding an item to the cart and tapping checkout), executes the test procedure to reproduce the defect, and compiles the test result into a test report. Advantageously, the present invention can automatically identify a quality assurance item requiring verification from a meeting conversation and directly trigger the corresponding test procedure, without requiring a user to manually create a defect ticket or write a test case, thereby greatly shortening the time from defect reporting to verification execution.

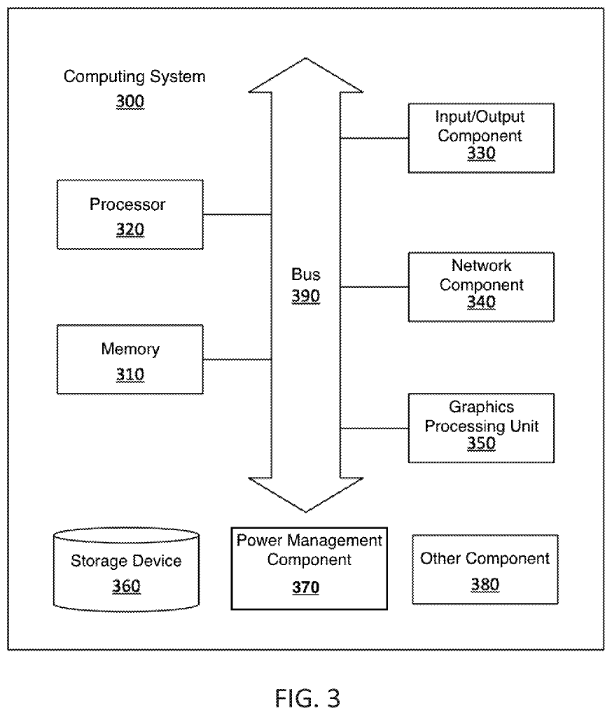

FIG. 3 is a schematic block diagram of a computing system according to an embodiment of the present invention.

Referring to FIG. 3, the method for automatically converting voice data into an executable workflow described herein is a computer-implemented method, which may be implemented on a computing system 300 having a plurality of hardware components. Similarly, the system for automatically converting voice data into an executable workflow described herein is also computer-implemented and may likewise be implemented on a computing system 300 having a plurality of hardware components. In some embodiments, the computing system 300 may be implemented, for example, in the form of an electronic device, including, but not limited to, one or more of the following components: a memory 310, a central processing unit (CPU) 320, an input/output component 330, a network component 340, and a graphics processing unit (GPU) 350, wherein these components may communicate and transfer data via a system bus 390. However, the present invention does not limit the specific model, quantity, and configuration of each component, and a person of ordinary skill in the art may adjust, select, or add or remove components according to the specific requirements and operating environment when implementing the present invention.

In some embodiments, the main computing core within the computing system 300 is one or more processors 320. The processor 320 may be responsible for the main computing process and related control logic of algorithms such as speech recognition, large language model inference, semantic analysis, to-do task classification, logical dependency relationship determination, and automated workflow generation. In some embodiments, the processor 320 is configured to execute processing instructions (i.e., machine-executable instructions) stored in a non-volatile computer-readable medium (for example, a storage device 360).

In some embodiments, data such as the electronic text content converted from the voice signal, and the to-do tasks, task types, logical dependency relationships, and automated workflow generated by the large language model, may be stored in the storage device 360, as intermediate processing results between the various processing stages.

In some embodiments, to improve the computational efficiency of large language model inference, the computing system 300 may further include one or more GPUs 350 specifically designed for performing large-scale parallel computation. The GPU 350 can effectively improve the computing capability of the system when the large language model performs semantic analysis on the electronic text content and generates the to-do tasks.

In some embodiments, the computing system 300 may implement a batch processing mechanism to simultaneously process a plurality of voice signals, thereby improving the efficiency of automated workflow generation. For example, the processor 320 may, through a parallel computing technique, start a plurality of threads. Each thread processes one voice signal, and the GPU 350 is utilized to accelerate the inference computation of the large language model.

In some embodiments, the computing system 300 may include various input/output components 330 for receiving user input and displaying system output. For example, the input/output component 330 may include a microphone, a keyboard, a mouse, a touchpad, a display screen, a speaker, and other types of sensing devices. In some embodiments, the input/output component 330 may receive a voice signal of a user through a microphone, or output, through a display screen, visualized content of the automated workflow generated by the present invention.

In some embodiments, the computing system 300 may also include a network component 340 for network communication. For example, the network component 340 may include a network interface card for a wired or wireless network connection, or a communication module for 3G, 4G, 5G, or other wireless communication technology. In some embodiments, the computing system 300 may call an external large language model application programming interface through the network component 340 or send an application programming interface call instruction to a target enterprise system to execute the action corresponding to a to-do task.

In some embodiments, the computing system 300 includes one or more memory components 310, such as a volatile memory component, for example, a random access memory (RAM). The memory 310 stores data and programs for executing algorithms such as speech recognition, large language model inference, and automated workflow generation.

In addition, the computing system 300 may further include one or more of the following components: a storage device 360, a power management component 370, and other components 380 (for example, other hardware components).

In some embodiments, the computing system 300 may include one or more storage devices 360, such as a non-volatile memory component, for example, a hard disk drive (HDD) or a solid-state drive (SSD). These storage devices 360 may be configured to store information such as the program code of the automated workflow generation system, the large language model parameters, and the speech recognition engine parameters. In addition, the storage device 360 may also be used to store intermediate results and final outputs such as the voice signal, the electronic text content, the to-do tasks, the task types, the logical dependency relationships, the automated workflow, and the programmatic instructions.

In some embodiments, the computing system 300 may include one or more power management components 370 for supplying power to and managing the power consumption of the various hardware components of the computing system 300. The power management component 370 may include a battery, a power converter, and other power management devices.

In some embodiments, the computing system 300 may further include other components 380, such as a cooling fan, a heat sink, and other various control and monitoring devices, and the present invention is not limited thereto.

In some embodiments, the system for automatically converting voice data into an executable workflow may be implemented by a variety of hardware architectures. Specifically, the system may be regarded as a functional entity including hardware components such as the memory 310, the processor 320, the input/output component 330, the network component 340, and the storage device 360, which implements core functions such as receiving a voice signal, performing semantic analysis using a large language model to generate a to-do task, determining a logical dependency relationship and generating an automated workflow, and calling an application to execute a to-do task.

In detail, the processor 320 is configured to execute program instructions stored in the memory 310, the instructions including: code instructing the processor 320 to receive a voice signal and convert the voice signal into electronic text content; code instructing the processor 320 to launch and control a large language model to perform a semantic analysis on the electronic text content, so as to identify a relationship among a verb, a time point, and a subject in the electronic text content and generate a to-do task; code instructing the processor 320 to classify the to-do tasks to generate a task type; code instructing the processor 320 to determine a logical dependency relationship among the to-do tasks according to a result of the semantic analysis and generate an automated workflow according to the task type and the logical dependency relationship; and code instructing the processor 320 to generate a programmatic instruction according to the automated workflow to call an application corresponding to a to-do task.

It should be noted that the system of the present invention includes hardware components such as the memory 310, the processor 320, and the input/output component 330. The speech recognition engine, the large language model, and the automated workflow generation module are stored in the memory 310 or the storage device 360 of the system in the form of program code and parameters and are loaded and executed by the processor 320. That is, the system does not directly include the speech recognition engine, the large language model, and the automated workflow generation module as hardware components, but rather calls and runs these modules by executing the program code stored in the memory 310, so as to implement the aforementioned method steps. It should be understood that the specific technical details of the above system implementation have been described in detail in the preceding method description of this specification. The system implementation of the present invention is closely related to the method implementation, and the function of each module of the system corresponds to each step of the method. For example, the module in the system for receiving a voice signal and converting the voice signal into electronic text content corresponds to step S100, the module for performing semantic analysis on the electronic text content using the large language model to generate a to-do task corresponds to step S110, the module for classifying the to-do tasks to generate a task type corresponds to step S120, the module for determining the logical dependency relationship among the to-do tasks corresponds to step S130, the module for generating the automated workflow corresponds to step S140, and the module for generating a programmatic instruction to call an application corresponds to step S150. Since the specific implementation of these steps has been described in detail in the preceding part of this specification, a person of ordinary skill in the art should be able to understand the specific implementation of the corresponding system, and further description thereof is omitted here.

In summary, the method and system for automatically converting voice data into an executable workflow provided by the present invention can perform semantic analysis, through a large language model, on electronic text content converted from a voice signal and can automatically extract to-do tasks and determine logical dependency relationships among the to-do tasks from unstructured conversation content, thereby constructing an automated workflow composed of process nodes and logic constructs and directly calling a corresponding application through a programmatic instruction to execute the action corresponding to each to-do task. Accordingly, the present invention can achieve end-to-end automation from a meeting conversation to actual task execution, allowing a user to complete all subsequent execution actions without manually organizing meeting content, creating a task list, or switching between different applications, thereby greatly reducing the time cost of manual processing and improving the overall operating efficiency of an enterprise.

Based on the above description, it is apparent that various techniques may be used to implement the concepts described in the present application without departing from the scope of these concepts. In addition, although the concepts have been described with specific reference to certain embodiments, a person of ordinary skill in the art will recognize that changes may be made in form and detail without departing from the scope of these concepts. As such, the described embodiments are to be considered in all respects as illustrative and not restrictive. Moreover, it should be understood that the present application is not limited to the specific embodiments described above, but that many rearrangements, modifications, and substitutions may be made without departing from the scope of the present invention.

What is claimed is:

1. A method for automatically converting voice data into an executable workflow, executed by a computing device, the method comprising:
receiving a voice signal and converting the voice signal into electronic text content;
performing, using a large language model, a semantic analysis on the electronic text content to identify a relationship among a plurality of verbs, a plurality of time points and at least one subject in the electronic text content and generating a plurality of to-do tasks accordingly, wherein each of the plurality of to-do tasks includes at least one of a task executor and a task completion deadline;
classifying the plurality of to-do tasks according to the plurality of verbs and the plurality of time points to generate a plurality of task types;
determining a logical dependency relationship among the plurality of to-do tasks according to a result of the semantic analysis;
generating an automated workflow including at least one process node and at least one logic construct according to the plurality of task types and the logical dependency relationship; and
generating at least one programmatic instruction according to the automated workflow to call an application corresponding to each of the plurality of to-do tasks.

2. The method of claim 1, further comprising:
extracting a data query requirement from the electronic text content;
constructing a contextual prompt instruction according to the data query requirement;
translating the contextual prompt instruction into a structured query language, so as to obtain target data from at least one data source; and
generating a corresponding visualized output according to the target data.

3. The method of claim 1, wherein the at least one logic construct includes at least one of the following:
a conditional execution branch configured to determine a subsequent process node of the at least one process node according to an execution result of the plurality of to-do tasks;
a parallel execution branch configured to simultaneously call the application corresponding to each of the plurality of to-do tasks; and
a waiting condition configured to suspend execution of the automated workflow until the waiting condition is satisfied.

4. The method of claim 1, wherein generating the at least one programmatic instruction to call the application corresponding to each of the plurality of to-do tasks further comprises:
determining a target enterprise system according to the task executor in each of the plurality of to-do tasks;
generating an application programming interface (API) call instruction of the target enterprise system according to each of the plurality of to-do tasks; and
sending the application programming interface call instruction to the target enterprise system, so as to execute the programmatic instruction corresponding to each of the plurality of to-do tasks.

5. The method of claim 1, further comprising:
identifying at least one item to be verified from the electronic text content according to a result of the semantic analysis;
generating and executing a corresponding test procedure according to the item to be verified; and
generating a test report according to an execution result of the corresponding test procedure.

6. The method of claim 2, wherein constructing the contextual prompt instruction further comprises:
identifying a speaker feature of a speaker who raised the data query requirement, wherein the speaker feature includes a department attribute or a permission level; and
encapsulating the speaker feature into the contextual prompt instruction, such that the structured query language is limited to a data access scope corresponding to the speaker feature, so as to perform permission filtering on the data source.

7. A system for automatically converting voice data into an executable workflow, implemented by a computing device, the system comprising:
a memory configured to store at least one instruction; and
a processor coupled to the memory and configured to execute the at least one instruction to:
receive a voice signal and convert the voice signal into electronic text content;
perform, using a large language model, a semantic analysis on the electronic text content to identify a relationship among a plurality of verbs, a plurality of time points, and at least one subject in the electronic text content and generate a plurality of to-do tasks accordingly, wherein each of the plurality of to-do tasks includes at least one of a task executor and a task completion deadline;
classify the plurality of to-do tasks according to the plurality of verbs and the plurality of time points, so as to generate a plurality of task types;
determine a logical dependency relationship among the plurality of to-do tasks according to a result of the semantic analysis;
generate an automated workflow including at least one process node and at least one logic construct according to the plurality of task types and the logical dependency relationship; and
generate at least one programmatic instruction according to the automated workflow to call an application corresponding to each of the plurality of to-do tasks.

8. The system of claim 7, wherein the processor is further configured to execute the at least one instruction to:
extract a data query requirement from the electronic text content;
construct a contextual prompt instruction according to the data query requirement;
translate the contextual prompt instruction into a structured query language, so as to obtain target data from at least one data source; and
generate a corresponding visualized output according to the target data.

9. The system of claim 7, wherein the at least one logic construct includes at least one of the following:
a conditional execution branch configured to determine a subsequent process node of the at least one process node according to an execution result of the plurality of to-do tasks;
a parallel execution branch configured to simultaneously call the application corresponding to each of the plurality of to-do tasks; and
a waiting condition configured to suspend execution of the automated workflow until the waiting condition is satisfied.

10. The system of claim 7, wherein generating the at least one programmatic instruction to call the application corresponding to each of the plurality of to-do tasks further comprises:
determining a target enterprise system according to the task executor in each of the plurality of to-do tasks;
generating an application programming interface (API) call instruction of the target enterprise system according to each of the plurality of to-do tasks; and
sending the application programming interface call instruction to the target enterprise system, so as to execute the programmatic instruction corresponding to each of the plurality of to-do tasks.

11. The system of claim 7, wherein the processor is further configured to execute the at least one instruction to:
identify at least one item to be verified from the electronic text content according to a result of the semantic analysis;
generate and execute a corresponding test procedure according to the item to be verified; and
generate a test report according to an execution result of the corresponding test procedure.

12. The system of claim 8, wherein, when constructing the contextual prompt instruction, the processor is further configured to execute the at least one instruction to:
identify a speaker feature of a speaker who raised the data query requirement, wherein the speaker feature includes a department attribute or a permission level; and
encapsulate the speaker feature into the contextual prompt instruction, such that the structured query language is limited to a data access scope corresponding to the speaker feature, so as to perform permission filtering on the data source.
